(19) United States
(12) Patent Application Publication
(10) Pub. No.: US 2009/0167070 A1
(43) Pub. Date: Jul. 2, 2009

(54) Armrest For Motor Vehicle Seat Assembly

(75) Inventors: Yi-Ru Chen, Farmington Hills, MI (US); Robert J. Hazlewood, Plymouth, MI (US)

Correspondence Address: GIFFORD, KRASS, SPRINKLE,;ANDERSON & CITKOWSKI, P.C., P.O. BOX 7021, TROY, MI, 48007-7021, US

(73) Assignee: Toyota Motor Engineering & Manufacturing North America, Inc., Erlanger, KY (US)

(21) Appl. No.: 11/966,155

(22) Filed: Dec. 28, 2007

(51) Int. Cl. B60N 2/46

(52) U.S. Cl. 297/411.32

(57) ABSTRACT

An armrest for a seat assembly includes has a support surface for supporting an arm of the occupant and a bottom surface opposite the support surface. The armrest is pivotally coupled to the seat back for movement about a pivot axis between a use position, wherein the support surface extends generally orthogonally relative to the seat back to support the arm of the occupant, and a stored position, wherein the support surface of the armrest is generally parallel with the seat back. The entire support surface of the armrest is forward of the front surface of the seat back when the armrest is in the use position. Additionally, the pivot axis of the armrest is closer to the bottom surface of the armrest than the top support surface and is closer to the front surface of the seat back than the back surface.

### FIELD OF THE INVENTION

The invention relates to motor vehicle seat assemblies. More particularly, the invention relates to an armrest for use in a motor vehicle assembly and having an offset pivot about which the armrest moves between use and stored positions.

### BACKGROUND OF THE INVENTION

Motor vehicle seat assemblies may include an armrest for supporting an arm of an occupant seated on a seat assembly. Typically, the armrest is movable about a fixed pivot between a use position, wherein an arm support surface of the armrest extends generally horizontally from a seat back of the seat assembly, and a stored position, wherein the armrest extends longitudinally along a side of the seat back when the armrest is not in use. The fixed pivot is conventionally centered with respect to the side profile or shape of the armrest. Most vehicle manufacturers have requirements for the design of the armrest, such as a minimum height or a minimum length for the support surface. Such requirements, however, can potentially conflict with other design criteria or conditions, such as tight packaging space within the motor vehicle. Therefore, it remains desirable to design an improved motor vehicle seat assembly with an armrest that meets predetermined design requirements and, at the same time, accommodates other design criteria, such as limited packaging space within the motor vehicle.

### SUMMARY OF THE INVENTION

According to one aspect of the invention, a seat assembly for a motor vehicle includes a seat cushion, a seat back and an armrest. The seat back is coupled to the seat cushion and has a front surface for supporting a back of an occupant seated on the seat cushion. The seat back has a back surface opposite the front surface. The armrest has a support surface for supporting an arm of the occupant and a bottom surface opposite the support surface. The armrest is pivotally coupled to the seat back for movement about a pivot axis between a use position, wherein the support surface extends generally orthogonally relative to the seat back to support the arm of the occupant, and a stored position, wherein the support surface of the armrest is generally parallel with the seat back. The pivot axis is closer to the bottom surface of the armrest than the support surface and is also closer to the front surface of the seat back than the back surface, so as to meet or exceed minimum armrest height and length or extension requirements while minimizing the overall package size of the seat assembly.

According to another embodiment of the invention, a seat assembly for a motor vehicle includes a seat cushion, a seat back and an armrest. The seat back is coupled to the seat cushion and has a front surface for supporting a back of an occupant seated on the seat cushion. The seat back has a back surface opposite the front surface. The armrest has a support surface for supporting an arm of the occupant and a bottom surface opposite the support surface. The armrest is pivotally coupled to the seat back for movement about a pivot axis between a use position, wherein the support surface extends generally orthogonally relative to the seat back to support the arm of the occupant, and a stored position, wherein the support surface of the armrest is generally parallel with the seat back. The entire support surface of the armrest is forward of the front surface of the seat back when the armrest is in the use position.

### BRIEF DESCRIPTION OF THE DRAWINGS

Advantages of tie present invention will be readily appreciated as the same becomes better understood by reference to the following detailed description when considered in connection with the accompanying drawings, wherein:

FIG. 1 is a side elevational view of a seat assembly according to one embodiment of the invention with an armrest of the seat assembly being shown in a use position;

FIG. 2 is a side elevational view of the seat assembly of FIG. 1 with the armrest in a stored position; and

FIG. 3 is a front elevational view of the seat assembly shown illustratively in a motor vehicle passenger compartment, with the armrest in the stored position.

### DETAILED DESCRIPTION OF THE INVENTION

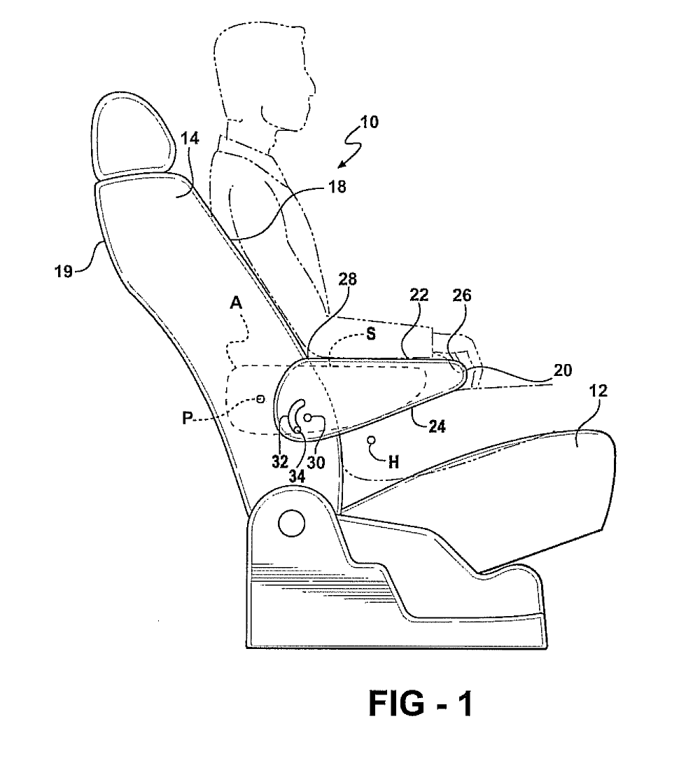

Referring to tie FIGS. 1-3, a seat assembly 10 is shown coupled to a floor of a passenger compartment in a motor vehicle. The seat assembly 10 includes a generally horizontal seat cushion 12 and a generally upright seat back 14 for supporting die back of an occupant seated on the seat cushion 12. The seat back 14 has opposite front 18 and rear 19 surfaces each extending transversely between spaced apart and opposite sides 21, 23 of the seat back 14. The seat assembly 10 also includes an armrest 20 pivotally coupled to one of the sides 21 of the seat back 14 for movement about a pivot pin or axis 30 between a use position generally orthogonal relative to the seat back 14 for supporting an arm of an occupant seated on the seat assembly 10 and a stored position disposed along a side 16 of the seat back 14.

The armrest 20 includes a substantially planar support surface 22 presented for supporting an arm of an occupant seated on the seat assembly 10 when the armrest 20 is in the use position. The support surface 22 has opposite front 26 and rear 28 ends. The armrest 20 also includes a bottom surface 24 opposite the support surface 22.

The armrest 20 may be guided between the use and stored positions by a slot 32 and pin 34 mechanism. The slot 32 illustratively may be formed in the armrest 20 and the pins 34 may extend from the seat back 14 through the slot 32. Contact between the pin 34 and the opposite ends of the slot 32 define the use and stored positions of the armrest 20.

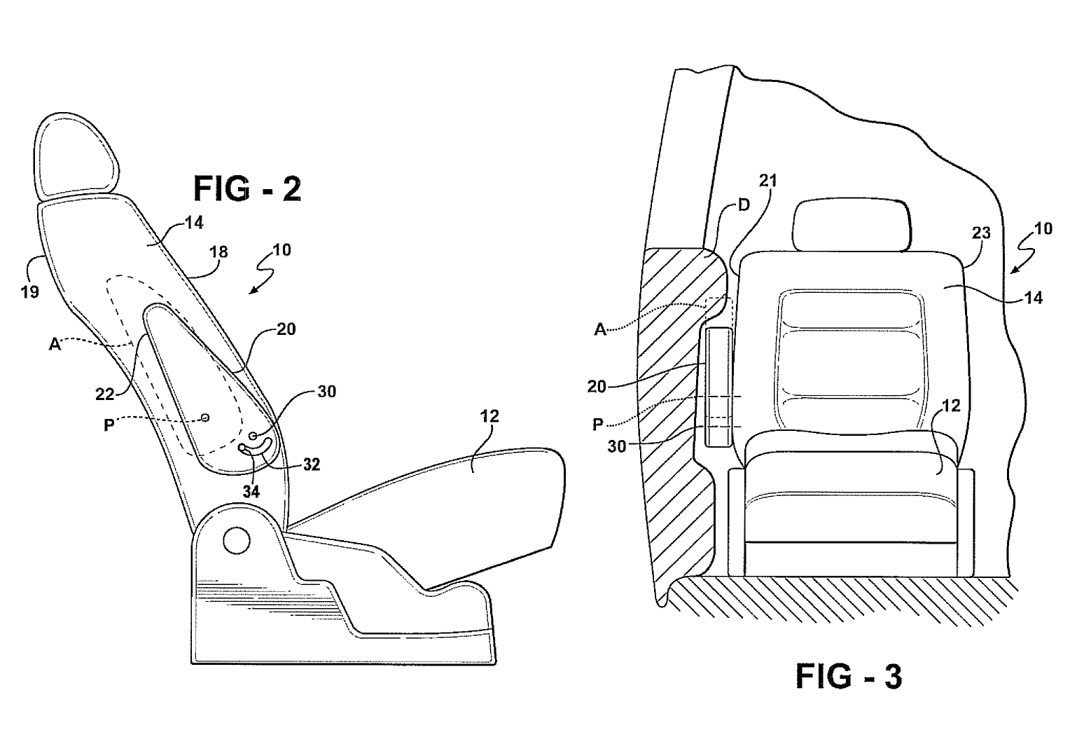

In FIGS. 1 and 2, a conventional armrest A is shown illustratively for purposes of comparison with the armrest 20 of the present invention. The conventional armrest A is shown pivotally coupled to the seat back 14 at a conventionally located pivot axis P. The pivot axis 30 of the armrest 20 of the present invention is located downwardly and forwardly (as viewed in the figures) on the seat back 14 relative to the conventionally located pivot axis P. More specifically, the pivot axis 30 extends in a transverse direction through a front half of the seat back 14 and is closer to the front surface 18 of the seat back 14 than the back surface 19. The pivot axis 30 also extends in the transverse direction through a bottom half of the armrest 20 and is closer to a bottom surface 24 of the armrest than the support surface 22.

The occupant-supporting surfaces of the seat, including the front surfaces of the seat back and the support surface of the armrest, may be described in die context of a seat hip pivot axis (“H-point”). Thus, in one embodiment of the invention, tie support surface 22 of the armrest 20 extends at least 250 mm forward of the rear end 28 of the support surface 22, and between 150 mm and 180 mm above the H-point. Defining the location and length of the support surface 22 in terms of the H-point as described above ensures that the armrest 20 remains comfortable to use while minimizing the overall packaging size of the seat assembly 10 when the armrest 20 is in the stored position.

In the use position (FIG. 1), the armrest 20 of the present invention has a support surface 22 that is substantially at the same height and orientation as the support surface S of the conventional armrest A. In the stored position (FIG. 2), however, the conventional armrest A extends higher along the side of the seat back 14 than the armrest 20 of the present invention. As a result, the conventional armrest A may interfere with adjacent components in the vehicle, such as an interior quarter trim C-pillar panel, as illustrated at D in FIG. 3. Thus, comparing the armrest 20 of the present invention with the conventional armrest A (shown in dashed lines), the lower and more forward location of the pivot axis 30 allows for a support surface 22 that meets or exceeds a minimum support surface height and/or length requirements in the use position and, at the same time, results in an armrest 20 that does not extend as high along the side of the seat back 14 as the conventional armrest A in the stored position.

The lower and more forwardly located pivot axis 30 of the armrest 20 of the present invention further allows the support surface 22 to be disposed at or forwardly of a front-most surface 18 of the seat back 14 or bolster of the seat back 14. As a result, nearly the entire support surface 22 is accessible for use by the occupant of the seat assembly 10, unlike in the conventional armrest A where a substantial portion of the support surface S is located behind the front-most surface 20 of the seat back 14 or bolster of the seat back 14. The armrest 20, as described herein, provides a number of advantages over the conventional armrest A. The support surface 22 of the armrest 20 of the present invention can meet or exceed minimum armrest height and length requirements when the armrest 20 is in the use position without sacrificing overall packaging size when the armrest 20 is in the stored position.

The invention has been described in an illustrative manner. It is, therefore, to be understood that the terminology used is intended to be in the nature of words of description rather than of limitation. Many modifications and variations of the invention are possible in light of the above teachings. The seat assembly may, for example, include an armrest at each side of the seat back. Thus, within the scope of the appended claims, the invention may be practiced other than as specifically described.

I claim:

1. A seat assembly for a motor vehicle, said seat assembly comprising:
a seat cushion;
a seat back coupled to the seat cushion and having a front surface for supporting a back of an occupant seated on the seat cushion, the seat back having a back surface opposite the front surface; and
an armrest pivotally coupled to an exposed side of the seat back at a location between the front and rear surfaces, said armrest having a support surface for supporting an arm of the occupant and a bottom surface opposite the support surface, said armrest pivoting about a pivot axis between a use position, wherein the support surface extends generally orthogonally relative to the seat back to support the arm of the occupant, and a stored position, wherein the support surface of the armrest is generally parallel with the seat back,
the pivot axis being relocated from a midpoint location of the exposed seat back side and closer to the bottom surface of said armrest than the support surface, the pivot axis also being relocated closer to the front surface of the seat back than the back surface, in order that said armrest establishes a minimum height and length for supporting an occupant's arm in the use position while minimizing an overall package size when pivoted to the stored position.

2. The seat assembly as set forth in claim 1, wherein the pivot axis extends through a lower half of the armrest.

3. The seat assembly as set forth in claim 2, wherein the pivot axis extends transversely through a front half of the seat back.

4. The seat assembly as set forth in claim 3, wherein the support surface is generally planar and extends between opposite front and rear edges.

5. The seat assembly as set forth in claim 4, wherein the rear edge is disposed at or forward of a forward-most portion of the front surface of the seat back when the armrest is in the use position.

6. The seat assembly as set forth in claim 5, wherein the support surface is located between 150 mm and 180 mm above a seat hip pivot axis of the occupant when the armrest is in the use position.

7. A seat assembly for a motor vehicle, said seat assembly comprising:
a seat cushion;
a seat back coupled to the seat cushion and having a front surface for supporting a back of an occupant seated on the seat cushion, the seat back having a back surface opposite the front surface;
an armrest having a support surface for supporting an arm of the occupant and a bottom surface opposite the support surface, the armrest being pivotally coupled to an exposed side of the seat back for movement about a pivot axis located towards the front surface of the seat back and between a use position, wherein the support surface extends generally orthogonally relative to the seat back to support the arm of the occupant, and a stored position, wherein the support surface of the armrest is generally parallel with the seat back, the entire support surface of the armrest being forward of the front surface of the seat back when the armrest is in the use position; and
a slot being formed in said armrest offset from said pivot axis, a pin extending laterally from the seat back and seating within the slot for movement between the use and stored positions.

8. The seat assembly as set forth in claim 7, wherein the support surface extends between opposite front and rear edges, the support surface being generally planar.

9. The seat assembly as set forth in claim 8, wherein the support surface of the armrest extends at least 250 mm forward of a seat hip pivot axis of the occupant and between 150 mm and 180 mm above the seat hip pivot axis.

10. The seat assembly as set forth in claim 9, wherein the pivot axis extends through a lower half of the armrest.

11. The seat assembly as set forth in claim 10, wherein the pivot axis extends transversely though a front half of the seat back.
